(19) United States
(12) Patent Application Publication
(10) Pub. No.: US 2026/0100160 A1
(43) Pub. Date: Apr. 9, 2026

(54) Display Panel and Display Device Including the Same

(71) Applicant: LG Display Co., Ltd., Seoul (KR)

(72) Inventors: Hyun Gi Hong, Paju-si (KR); Sang Jin Nam, Paju-si (KR); Seung Jin Yoo, Paju-si (KR)

(21) Appl. No.: 19/294,745

(22) Filed: Aug. 8, 2025

(30) Foreign Application Priority Data
Oct. 4, 2024 (KR) 10-2024-0134839

(51) Int. Cl. G09G 3/3233; G09G 3/20

(52) U.S. Cl. CPC G09G 3/3233; G09G 3/2074; G09G 2300/0842; G09G 2310/08; G09G 2320/068; G09G 2330/021; G09G 2370/08

(57) ABSTRACT

The present disclosure relates to a display panel and a display device including the same, and each of sub-pixels of the display panel includes a first light-emitting element, a second light-emitting element, and a first transistor connected to the first light-emitting element and the second light-emitting element. A first alternating-current voltage that is applied to one electrode of an anode electrode and a cathode electrode of the first light-emitting element periodically changes between a first voltage and a second voltage. A second alternating-current voltage that is applied to one electrode of an anode electrode and a cathode electrode of the second light-emitting element periodically changes between the first voltage and the second voltage.

### CROSS-REFERENCE TO RELATED APPLICATION

This application claims priority to and the benefit of Republic of Korea Patent Application No. 10-2024-0134839, filed on Oct. 4, 2024, which is hereby incorporated by reference in its entirety.

### BACKGROUND

### Field

The present disclosure relates to a display panel capable of varying a viewing and angle and a display device including the same.

### Discussion of Related Art

A viewing angle variable technology is being applied to display devices. The variable viewing angle technology allows video content or visual information reproduced on a display device to be visible to a user within a narrow viewing angle range or to multiple users within a wide viewing angle range.

As the market for future vehicles such as electric vehicles and autonomous vehicles expands, the demand for in-vehicle display devices is growing rapidly. Research is being conducted on how to split the screen of an in-vehicle display device so that one portion of the screen is controlled at a narrow viewing angle and another portion is controlled at a wide viewing angle. This technology can display private content or information that only a specific user can see on pixels driven at the narrow viewing angle, while displaying shared content that multiple users can view together on the pixels driven at the wide viewing angle. To achieve this, a pixel technology is required that can freely control each pixel at the narrow viewing angle or at the wide viewing angle. Various studies for electrically switching a viewing angle mode of pixels are conducted. However, to implement a method for electrically switching the viewing angle mode of the pixels, light-emitting elements, switch elements, and gate signals and control signals for mode switching need to be additionally provided to a pixel circuit. For this reason, there are problems in that the configuration of the pixel circuit becomes complicated and gate driving circuits are additionally provided.

### SUMMARY

Embodiments of the present disclosure solve the above-described shortcomings and/or problems.

The present disclosure provides a display panel that easily performs viewing angle control and has a pixel circuit with a simple configuration, and a display device including the same.

The problems addressed by the embodiments of the present disclosure are not limited to those described above, and other problems not described will be clearly understood by those skilled in the art from the following description.

A display panel according to one embodiment includes: a plurality of data lines; a plurality of gate lines; a plurality of power lines; and a plurality of sub-pixels each electrically connected to the data line, the gate line, and the power line. Each of the sub-pixels includes: a first light-emitting element, a second light-emitting element, and a first transistor connected to the first light-emitting element and the second light-emitting element. A first alternating-current voltage that is applied to one electrode of an anode electrode and a cathode electrode of the first light-emitting element periodically changes between a first voltage and a second voltage. A second alternating-current voltage that is applied to one electrode of an anode electrode and a cathode electrode of the second light-emitting element periodically changes between the first voltage and the second voltage. The second voltage is a voltage lower than the first voltage.

The display panel may further include: a first lens that overlaps a light emission area of the first light-emitting element; and a second lens that overlaps a light emission area of the second light-emitting element.

The first alternating-current voltage applied to the first light-emitting element and the second alternating-current voltage applied to the second light-emitting element may have waveforms with phases opposite to each other.

When the first alternating-current voltage applied to the first light-emitting element is the first voltage, the second alternating-current voltage applied to the second light-emitting element may be the second voltage.

The display panel may further include: a first switch element configured to select one of the first voltage and the second voltage and supply the selected one to the first light-emitting element; and a second switch element configured to select one of the first voltage and the second voltage and supply the selected one to the second light-emitting element.

The sub-pixel may further include: a capacitor connected between a first node and a second node, a second transistor that is turned on in response to a gate on voltage of a gate signal applied to the gate line to electrically connect the data line to the second node, and a third transistor that is turned on in response to the gate on voltage of the gate signal to electrically connect the first node to a reference voltage line. Cathode electrode of the first light-emitting element and the cathode electrode of the second light-emitting element may be connected to the first node. A first power line to which the first alternating-current voltage is applied may be connected to the anode electrode of the first light-emitting element. A second power line to which the second alternating-current voltage is applied may be connected to the anode electrode of the second light-emitting element. A third power line to which a pixel ground voltage is applied may be connected to a third node.

The first transistor may include a first electrode connected to the first node, a gate electrode connected to the second node, and a second electrode connected to the third node. The second transistor may include a first electrode connected to the data line, a gate electrode connected to the gate line, and a second electrode connected to the second node. The third transistor may include a first electrode connected to the first node, a gate electrode connected to the gate line, and a second electrode connected to the reference voltage line. A data voltage of pixel data or a black grayscale voltage is applied to the data line.

The pixel ground voltage may have the same voltage level as that of the second voltage.

The sub-pixel further may include: a capacitor connected between a second node and a third node, a second transistor that is turned on in response to a gate on voltage of a gate signal to electrically connect the data line to the second node, and a third transistor that is turned on in response to the gate on voltage of the gate signal applied to the gate line to electrically connect the third node to a reference voltage line. The anode electrode of the first light-emitting element and the anode electrode of the second light-emitting element may be connected to the third node. A first power line to which a pixel driving voltage is applied may be connected to a first node. A second power line to which the first alternating-current voltage is applied may be connected to the cathode electrode of the first light-emitting element. A third power line to which the second alternating-current voltage is applied may be connected to the cathode electrode of the second light-emitting element.

The first transistor may include a first electrode connected to the first node, a gate electrode connected to the second node, and a second electrode connected to the third node. The second transistor includes a first electrode connected to the data line, a gate electrode connected to the gate line, and a second electrode connected to the second node. The third transistor may include a first electrode connected to the third node, a gate electrode connected to the gate line, and a second electrode connected to the reference voltage line. A data voltage of pixel data or a black grayscale voltage may be applied to the data line.

The pixel driving voltage may have the same voltage level as that of the first voltage.

The first light-emitting element may emit light in a first viewing angle mode. The second light-emitting element may emit light in a second viewing angle mode having a viewing angle different from a viewing angle in the first viewing angle mode.

A display device according to one embodiment includes: a display panel in which a plurality of data lines, a plurality of gate lines, a plurality of power lines, and a plurality of sub-pixels each electrically connected to the data line, the gate line, and the power line are disposed; a data driver electrically connected to the data lines; and a gate driver electrically connected to the gate lines.

The display device may further include: a timing controller configured to transmit pixel data of an input video to the data driver and control operation timings of the data driver and the gate driver. The timing controller may divide one frame period into at least a first sub-frame period, a second sub-frame period, a third sub-frame period, and a fourth sub-frame period.

A data voltage of first pixel data or a black grayscale voltage may be applied to the data lines during the first sub-frame period. The black grayscale voltage may be applied to the data lines during the second sub-frame period. A data voltage of second pixel data or a black grayscale voltage may be applied to the data lines during the third sub-frame period. The black grayscale voltage may be applied to the data lines during the fourth sub-frame period. The first alternating-current voltage may be applied to the anode electrode of the first light-emitting element. The second alternating-current voltage may be applied to the anode electrode of the second light-emitting element. A pixel ground voltage set as the second voltage may be applied to the cathode electrode of the first light-emitting element and the cathode electrode of the second light-emitting element. During the first and second sub-frame periods, the first alternating-current voltage may be the first voltage and the second alternating-current voltage may be the second voltage. During the third and fourth sub-frame periods, the first alternating-current voltage may be the second voltage and the second alternating-current voltage may be the first voltage.

A data voltage of first pixel data or a black grayscale voltage may be applied to the data lines during the first sub-frame period. The black grayscale voltage may be applied to the data lines during the second sub-frame period. A data voltage of second pixel data or a black grayscale voltage may be applied to the data lines during the third sub-frame period. The black grayscale voltage may be applied to the data lines during the fourth sub-frame period. A pixel driving voltage set as the first voltage may be applied to the anode electrode of the first light-emitting element and the anode electrode of the second light-emitting element. The first alternating-current voltage may be applied to the cathode electrode of the first light-emitting element. The second alternating-current voltage may be applied to the cathode electrode of the second light-emitting element. During the first and second sub-frame periods, the first alternating-current voltage may be the second voltage and the second alternating-current voltage may be the first voltage. During the third and fourth sub-frame periods, the first alternating-current voltage may be the first voltage and the second alternating-current voltage may be the second voltage.

The display panel may further include: a first switch element configured to select one of the first voltage and the second voltage and supply the selected one to the first light-emitting element; and a second switch element configured to select one of the first voltage and the second voltage and supply the selected one to the second light-emitting element.

According to the embodiments of the present disclosure, it is possible to reduce the power consumption of the display device by driving the light-emitting element of each color with maximum light emission efficiency. Therefore, the present disclosure can drive the display device with low power.

According to the embodiments of the present disclosure, it is possible to freely switch a viewing angle of each sub-pixel using a pixel circuit with a simple structure.

According to the embodiments of the present disclosure, it is possible to implement a display device capable of switching a viewing angle mode of each sub-pixel without additionally providing gate driving circuits.

The effects of the present disclosure are not limited to the effects described above, and other effects not described will be understood by those skilled in the art from the following description and the appended claims.

### BRIEF DESCRIPTION OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to an embodiment of the present disclosure;

FIG. 2 is a circuit diagram illustrating a pixel circuit according to an embodiment of the present disclosure;

FIG. 3 is a diagram illustrating an example of lenses provided in each sub-pixel according to an embodiment of the present disclosure;

FIG. 4 is a diagram illustrating an example of a current density-efficiency ratio of a light-emitting element by color according to an embodiment of the present disclosure;

FIG. 5 is a diagram illustrating an example where a duty rate of a micro LED is different with the same target luminance according to an embodiment of the present disclosure;

FIG. 6 is a diagram illustrating a frame period according to an embodiment of the present disclosure;

FIG. 7 is a waveform chart illustrating an example of signals that are applied to data lines and gate lines during first and second sub-frame periods illustrated in FIG. 6 according to an embodiment of the present disclosure;

FIG. 8 is a waveform chart illustrating an example of first and second pixel driving voltages that are applied to the pixel circuit illustrated in FIG. 2 according to an embodiment of the present disclosure;

FIG. 9 is a diagram illustrating an example of pixels in which a viewing angle is controlled independently in a display area of a display panel according to an embodiment of the present disclosure;

FIGS. 10 to 12 are diagrams illustrating a viewing angle control method of first and second sub-pixels illustrated in FIG. 9 according to an embodiment of the present disclosure;

FIG. 13 is a diagram illustrating a connection structure of a display panel and circuit boards in the display device according to an embodiment of the present disclosure;

FIG. 14 is a diagram illustrating paths of the first and second pixel driving voltages according to an embodiment of the present disclosure;

FIG. 15 is a diagram illustrating paths of first and second pixel driving voltages according to another embodiment of the present disclosure;

FIG. 16 is a circuit diagram illustrating a pixel circuit according to another embodiment of the present disclosure;

FIG. 17 is a waveform chart illustrating an example of signals that are applied to data lines and gate lines during first and second sub-frame periods illustrated in FIG. 16 according to an embodiment of the present disclosure;

FIG. 18 is a waveform chart illustrating an example of first and second pixel ground voltages that are applied to the pixel circuit illustrated in FIG. 16 according to an embodiment of the present disclosure;

FIGS. 19 to 21 are diagrams illustrating a viewing angle control method of first and second sub-pixels to which the pixel circuit illustrated in FIG. 16 is applied according to an embodiment of the present disclosure;

FIG. 22 is a diagram illustrating paths of the first and second pixel ground voltages according to an embodiment of the present disclosure; and

FIG. 23 is a diagram illustrating paths of first and second pixel ground voltages according to another embodiment of the present disclosure.

### DETAILED DESCRIPTION

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” and “having” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after”, “following”, “next to”, “before”, or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

The pixel circuit and the gate drive circuit of the display device may include a plurality of transistors. The transistor may be implemented as a thin film transistor (TFT). The transistors may be implemented as an oxide thin film transistor (oxide TFT) including an oxide semiconductor, a low temperature poly silicon TFT (LTPS TFT) including a low temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor), since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage VGH, and the gate-off voltage may be a gate low voltage VGL. In the case of a p-channel transistor, the gate-on voltage may be the gate low voltage VGL, and the gate-off voltage may be the gate high voltage VGH.

Hereinafter, various embodiments of the present disclosure will be described in detail with reference to the accompanying drawings.

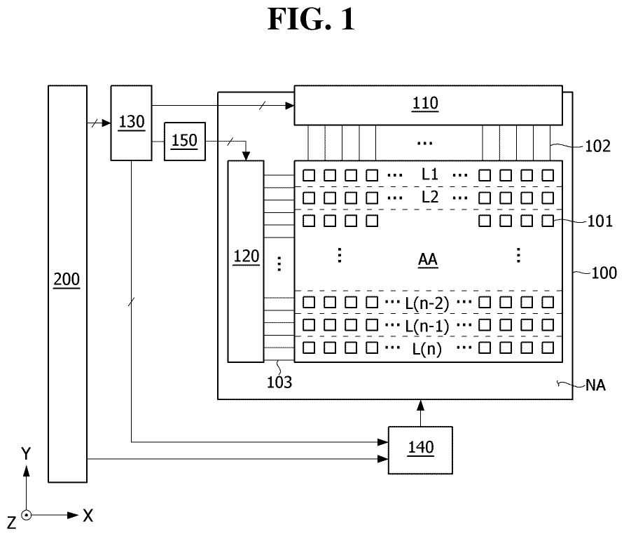

Referring to FIG. 1, a display device according to one embodiment of the present disclosure includes a display panel 100, a display panel driving circuit for writing pixel data to pixels 101 of the display panel 100, and a power supply 140 (e.g., a circuit) for generating power necessary for driving the pixels 101 and the display panel driving circuit.

A substrate of the display panel 100 may be, but is not limited to, a plastic substrate, a thin glass substrate, or a metal substrate. The display panel 100 may be, but is not limited to, a rectangular shaped panel having a length in the X-axis direction (or first direction), a width in the Y-axis direction (or second direction), and a thickness in the Z-axis direction (or third direction). For example, at least a portion of the display panel 100 may have a curved outer periphery.

The display panel 100 may be implemented as a non-transmissive display panel or a transmissive display panel. The transmissive display panel may be employed in a transparent display device in which an image is displayed on a screen and an actual object is visible beyond the display panel. The display panel 100 may be made as a flexible display panel. Additionally, the display panel 100 may be made of a stretchable panel that may be stretched.

A display area AA of the display panel 100 includes a pixel array for displaying an input image thereon. The display area AA includes a plurality of data lines 102, a plurality of gate lines 103 intersecting the data lines 102, and the pixels 101 arranged in a matrix form. The display panel 100 may further include power lines connected to the pixels 101 and reference voltage lines. The power lines are commonly connected to the pixels and supply voltages necessary for driving the pixels 101 to the pixels 101. The power lines may be implemented as long stripes of wires along either the first or second direction, or as mesh wires where the wires in the first direction and the wires in the second direction are electrically connected.

Each of the pixels 101 may be divided into a red (R) sub-pixel, a green (G) sub-pixel, and a blue (B) sub-pixel for color implementation. Each of the pixels may further include a white sub-pixel. Each sub-pixel includes a pixel circuit for driving a light-emitting element. Each of the pixel circuits is connected to the data lines, the gate lines, and the power lines. In the following, “pixel” may be interpreted as “sub-pixel”.

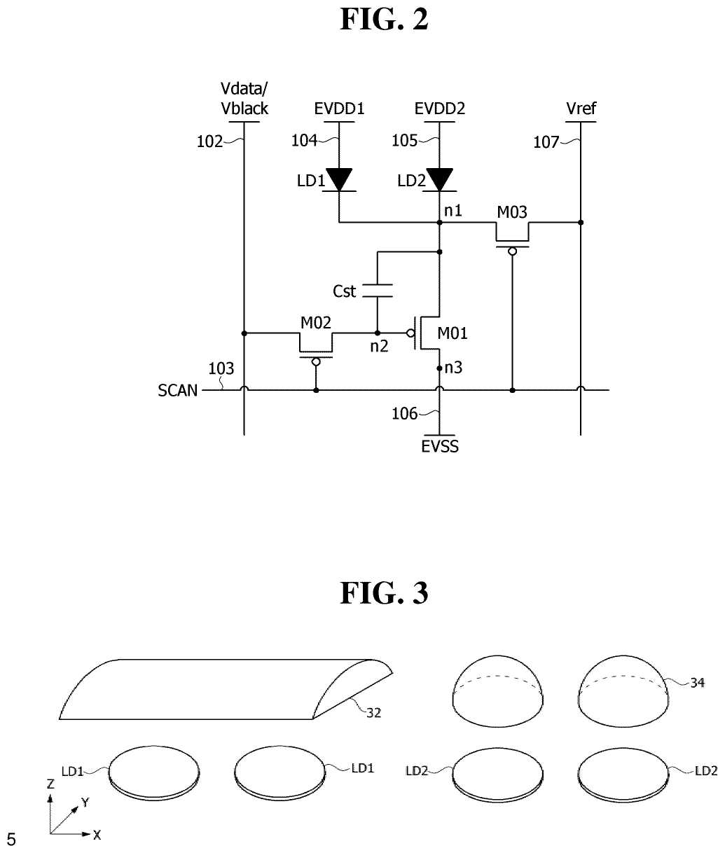

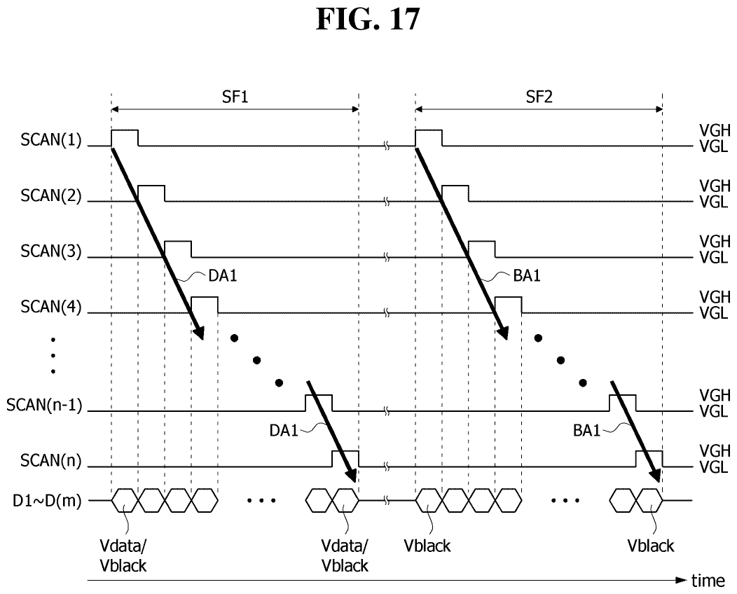

The pixel circuit of the sub-pixels may include a first light-emitting element LD1, a second light-emitting element LD2, and first transistors M01 and M11 connected to the light-emitting elements LD1 and LD2, as shown in FIGS. 2 and 16. An alternating voltage applied to either of the anode electrode and the cathode electrode of the first light-emitting element LD1 may vary periodically between the first and second voltages. An alternating voltage applied to either of the anode electrode and the cathode electrode of the second light-emitting element LD2 may vary periodically between the first and second voltages. The alternating voltage applied to the first light-emitting element LD1 and the alternating voltage applied to the second light-emitting element LD2 may have waveforms of an opposite phase with each other. Therefore, when the alternating voltage applied to the first light-emitting element LD1 is the first voltage, the alternating voltage applied to the second light-emitting element LD2 may be the second voltage. On the contrary, when the alternating voltage applied to the first light-emitting element LD1 is the second voltage, the alternating voltage applied to the second light-emitting element LD2 may be the first voltage.

Each of the sub-pixels emits light generated from the first light-emitting element at a wide viewing angle by diffusing it when driven in the first viewing angle mode. In contrast, each of the sub-pixels emit light generated from the second light-emitting element at a narrow viewing angle by concentrating it when driven in the second viewing angle mode. The viewing angle modes of the sub-pixels may be electrically controlled and switched.

The pixel array includes a plurality of pixel lines L1 to L(n). Each of the pixel lines L1 to L(n) includes one line of pixels arranged along the line direction (X-axis direction) in the pixel array of the display panel 100. The pixels arranged in one pixel line may share a gate line 103. The sub-pixels arranged in the column direction (Y-axis direction) along a data line direction may share the data line 102. One horizontal period is a time obtained by dividing one frame period by the total number of the pixel lines L1 to L(n).

Touch sensors may be arranged on the display panel 100 to sense touch inputs. The touch sensors may be arranged on the display panel 100 as an on-cell type or an add-on type, or implemented as in-cell type touch sensors embedded in the pixel array.

The power supply 140 generates the constant voltages (or direct current (DC) voltages) required for driving the pixel array and the display panel driving circuit of the display panel 100 using a DC-DC converter. The DC-DC converter may include a charge pump, a regulator, a buck converter, a boost converter, and the like. The power supply 140 may adjust the level of the DC input voltage input from a host system 200 to output constant voltages such as a gamma reference voltage, a gate-off voltage, a gate-on voltage, a pixel driving voltage, a pixel ground voltage, and the like. The gamma reference voltage is supplied to the data driver 110. The dynamic range of the data voltage output from the data driver 110 is determined by the voltage range of the gamma reference voltage. The dynamic range of the data voltage is the range of voltages between the uppermost grayscale voltage and the lowermost grayscale voltage.

The gate-on voltage and the gate-off voltage are supplied to a level shifter 150 and the gate driver 120. The constant voltages such as the pixel driving voltage and the pixel ground voltage are supplied to the pixels 101 via the power lines commonly connected to the pixels 101. The pixel ground voltage may be, but is not limited to, the ground voltage. The pixel driving voltage may be supplied from a main power source of the host system 200 to the display panel 100. In this case, the power supply 140 does not need to output the pixel driving voltage.

The power supply 140 may output a gamma reference voltage using a programmable gamma voltage circuit. The programmable gamma voltage circuit may vary the voltage level of the gamma reference voltage provided to the data driver 110 according to digital data from the timing controller 130.

The display panel driving circuit writes the pixel data of the input image to the pixels of the display panel 100 under the control of the timing controller 130. The display panel driving circuit includes the data driver 110 and the gate driver 120.

The display panel driving circuit may further include a touch sensor driver for driving touch sensors. The touch sensor driver is omitted from FIG. 1. The data driver 110 and the touch sensor driver may be integrated into one drive IC (Integrated Circuit). The timing controller 130, the power supply 140, the level shifter 150, the data driver 110, the touch sensor driver may be further integrated into the drive IC.

The data driver 110 receives the pixel data of the input image provided as a digital signal from the timing controller 130 and outputs data voltages of the pixel data. The data driver 110 converts the pixel data of the input image into a gamma compensation voltage using a digital-to-analog converter (DAC) to output the data voltage. The gamma reference voltage is divided into the gamma-compensated voltages for each grayscale by a voltage divider circuit in the data driver 110 and supplied to the DAC. The DAC generates the data voltage as the gamma compensated voltage corresponding to a grayscale value of the pixel data. The data voltage output from the DAC is output to the data line 102 through an output buffer in each of the data output channels of the data driver 110.

The data driver 110 may include sensing channels of an external compensation circuit electrically connected to the reference voltage line of the display panel 100. The sensing channels may include an analog-to-digital converter (hereinafter referred to as the “ADC”) to convert a current or voltage from the reference voltage line into digital data and transmit the digital data to the timing controller 130.

The maximum light emission efficiency period for each red, green, and blue light-emitting elements may have different data voltages. The data driver 110 may vary at least one of a dynamic range, a maximum voltage, and a minimum voltage of the red data voltage supplied to the red sub-pixel, the green data voltage supplied to the green sub-pixel, and the blue data voltage supplied to the blue sub-pixel to drive each of the red light emitting element, the green light emitting element, and the blue light emitting element at a maximum light emission efficiency period.

The gate driver 120 may be formed on the display panel 100. For example, the gate driver 120 may be arranged in the non-display area NA outside the display area AA in the display panel 100, or at least a portion thereof may be disposed in the display area AA.

The gate driver 120 may be disposed in either a left non-display area NA or a right non-display area NA outside the display area AA in the display panel 100 to supply the gate signal to the gate lines 103 in a single feeding method. In the single feeding method, the gate signal is applied to one ends of the gate lines. The gate driver 120 may be disposed in the left non-display area NA and the right non-display area NA in the display panel 100 to apply the gate signal to the gate lines 103 in a double feeding method. In the double feeding method, the gate signal is applied simultaneously to both ends of the gate lines 103. At least some circuits of the gate driver 120 may be disposed within the display area AA.

The gate driver 120 may output pulses of the gate signal and shift the pulses of the gate signal under the control of the timing controller 130 using one or more shift register.

The timing controller 130 receives the pixel data of the input image and a timing signal synchronized with the pixel data from the host system 200. The timing signal may include a vertical synchronization signal Vsync, a horizontal synchronization signal Hsync, and a data enable signal DE. A vertical period and a horizontal period may be known by counting the data enable signal DE, and thus the vertical synchronization signal Vsync and the horizontal synchronization signal Hsync may be omitted. The data enable signal DE has an interval of one horizontal period (1H).

The timing controller 130 may control the operation timings of the data driver 110 and the gate driver 120 based on the timing signals Vsync, Hsync, and DE received from the host system 200.

A gate timing control signal output from the timing controller 130 may be inputted to the shift register of the gate driver 120 through the level shifter 150. The level shifter 150 may receive the gate timing control signal and generate the start pulse and the clock to provide them to the gate driver 120. The input signal to the level shifter 150 is a signal of a digital signal voltage level. The clock output from the level shifter 150 may swing between the gate-on voltage and the gate-off voltage. A data timing control signal generated from the timing controller 130 is transmitted to the data driver 110.

The timing controller 130 may transmit the black grayscale data set regardless of the input image to the data driver 110. When the black grayscale data generated from the timing controller 130 is input to the data driver 110, the data driver 110 converts the black grayscale data into a black grayscale voltage. The data driver 110 may output a black grayscale voltage independent of the input image in a sub-frame period in which the black grayscale data is addressed to the sub-pixels at an increased frame rate under the control of the timing controller 130. The black grayscale voltage may be applied to the pixels 101 via the data lines. The black grayscale voltage may be a voltage such as a voltage of the black grayscale or the lowest grayscale of the pixel data, but is not limited thereto. Since both the first and second light-emitting elements are turned off in the sub-pixel to which the black grayscale voltage is applied, the sub-pixel does not emit light and is controlled to remain in an off state.

The host system 200 may scale an image signal from a video source to match the resolution of the display panel 100 and may transmit it to the timing controller 130 together with the timing control signal.

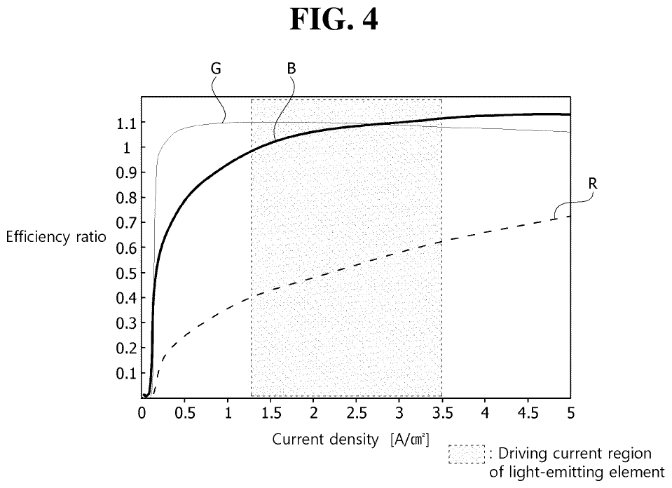

FIG. 2 is a circuit diagram illustrating a pixel circuit according to an embodiment of the present disclosure. FIG. 3 is a diagram illustrating an example of lenses provided in light-emitting elements according to an embodiment of the present disclosure.

Referring to FIGS. 2 and 3, the pixel circuit includes a first light-emitting element LD1 that emits light in a first viewing angle mode, a second light-emitting element LD2 that emits light in a second viewing angle mode, a first transistor M01 that drives the first and second light-emitting elements LD1 and LD2, a capacitor Cst connected between a first node n1 and a second node n2, a second transistor M02 that is turned on in response to a gate on voltage of a gate signal SCAN to electrically connect a data line 102 to the second node n2, and a third transistor M03 that is turned on in response to the gate on voltage of the gate signal SCAN to electrically connect the first node n1 to a reference voltage line 107. The transistors M01, M02, and M03 may be implemented by p-channel transistors. In this case, the gate on voltage is a gate low voltage, and a gate off voltage is a gate high voltage.

The second transistor M02 and the third transistor M03 may be controlled by the same gate signal SCAN, but the present disclosure is not limited thereto. For example, the second transistor M02 may be controlled by a first gate signal, and the third transistor M03 may be controlled by a second gate signal. In this case, the second transistor M02 and the third transistor M03 may be connected to different gate lines.

The pixel circuit may be connected to wires such as the data line 102 to which a data voltage Vdata and a black grayscale voltage Vblack are applied, a gate line 103 to which the gate signal SCAN is applied, a first power line 104 to which a first pixel driving voltage EVDD1 is applied, a second power line 105 to which a second pixel driving voltage EVDD2 is applied, a third power line 106 to which a pixel ground voltage EVSS is applied, and the reference voltage line 107 to which a reference voltage Vref is applied.

The first pixel driving voltage EVDD1 may have a first voltage level for causing the first light-emitting element LD1 turned on by raising an anode voltage of the first light-emitting element LD1 in the first viewing angle mode and have a second voltage level for causing the first light-emitting element LD1 turned off by lowering the anode voltage of the first light-emitting element LD1 in the second viewing angle mode. The second pixel driving voltage EVDD2 may have a first voltage level for causing the second light-emitting element LD2 turned on by raising an anode voltage of the second light-emitting element LD2 in the second viewing angle mode and have a second voltage level for causing the second light-emitting element LD2 turned off by lowering the anode voltage of the second light-emitting element LD2 in the first viewing angle mode. The first voltage level of each of the first and second pixel driving voltages EVDD1 and EVDD2 may be 9 V, but the present disclosure is not limited thereto. The first voltage level may be analyzed as a high voltage level, and the second voltage level may be analyzed as a low voltage level. The second voltage level of each of the first and second pixel driving voltages EVDD1 and EVDD2 may be 0 V, but the present disclosure is not limited thereto. The pixel ground voltage EVSS may be a voltage lower than the first voltage level of each of the first and second pixel driving voltages EVDD1 and EVDD2, for example, may be the second voltage level or 0 V, but the present disclosure is not limited thereto.

The data voltage Vdata may be selectively set to a voltage corresponding to the grayscale value of pixel data from voltages in a dynamic range of 2 V to 9 V, but the present disclosure is not limited thereto. The reference voltage Vref may be the same voltage as the first voltage level of each of the first and second pixel driving voltages EVDD1 and EVDD2 or 9 V, but the present disclosure is not limited thereto. A voltage of the gate signal SCAN includes a pulse that swings between the gate high voltage and the gate low voltage. The gate high voltage is 13 V and the gate low voltage is −13 V, but the present disclosure is not limited thereto.

Each of the first and second light-emitting elements LD1 and LD2 may include an anode electrode, a cathode electrode, and a light-emitting layer. The first and second light-emitting elements LD1 and LD2 may be light-emitting diodes such as an organic light-emitting diode (OLED) or a micro LED, but the present disclosure is not limited thereto. A micro LED chip may be implemented as a lateral structure or a flip chip structure. The micro LED chip may be connected to the first node n1 in a transfer process. The cathode electrode of each of the first and second light-emitting elements LD1 and LD2 is connected to the first node n1. The first pixel driving voltage EVDD1 is applied to the anode electrode of the first light-emitting element LD1, and the second pixel driving voltage EVDD2 is applied to the anode electrode of the second light-emitting element LD2.

As illustrated in FIG. 3, each of the sub-pixels may include lenses 32 and 34. A first lens 32 is a wide viewing angle lens provided above the first light-emitting element LD1. The first lens 32 overlaps a light emission area of the first light-emitting element LD1. The first lens 32 may be implemented by a semicylindrical lens to limit upper and lower viewing angles and widen right and left viewing angles. The first lens 32 is long in a right-left direction (or an X-axis direction) of the display panel 100 and is narrow in an up-down direction (a Y-axis direction) of the display panel 100. The first lens 32 condenses light of the first light-emitting element LD1 in the up-down direction and diffuses light with a wide viewing angle in the right-left direction to make light from the first light-emitting element LD1 travel with a wide viewing angle in the right-left direction.

The second lens 34 is a wide viewing angle lens provided above the second light-emitting element LD2. The second lens 34 overlaps a light emission area of the second light-emitting element LD2. The second lens 34 may be a semispherical lens that is thick in the center portion and thinner toward an edge in the up-down direction and the right-left direction. The second lens 34 condenses light of the second light-emitting element LD2 to make light emitted from the second light-emitting element LD2 travel with a narrow viewing angle in the up-down direction and the right-left directions.

The first and second lenses 32 and 34 may be implemented by a transparent medium or a transparent insulation layer pattern provided in the display panel 100, but the present disclosure is not limited thereto. The first and second lenses 32 and 34 can prevent a phenomenon that light from pixels is reflected on a windshield of a vehicle and a screen of the display device is viewed, by limiting upper and lower viewing angles of pixels.

The first transistor M01 includes a first electrode connected to the first node n1, a gate electrode connected to the second node n2, and a second electrode connected to a third node n3. The third power line 106 to which the pixel ground voltage EVSS is applied is connected to the third node n3. The capacitor Cst is connected between the first node n1 and the second node n2 and is charged with a gate-source voltage of the first transistor M01.

The second transistor M02 is connected between the data line 102 to which the data voltage Vdata of pixel data or the black grayscale voltage Vblack is applied and the second node n2 and is turned on in response to the gate on voltage of the gate signal SCAN. When the second transistor M02 is turned on, the data line 102 is electrically connected to the second node n2. The second transistor M02 includes a first electrode connected to the data line 102, a gate electrode connected to the gate line 103 to which the gate signal SCAN is applied, and a second electrode connected to the second node n2.

The third transistor M03 is connected between the reference voltage line 107 to which the reference voltage Vref is applied and the first node n1 and is turned on in response to the gate on voltage of the gate signal SCAN. When the third transistor M03 is turned on, the first node n1 may be electrically connected to the reference voltage line 107. The third transistor M03 includes a first electrode connected to the first node n1, a gate electrode connected to the gate line 103 to which the gate signal SCAN is applied, and a second electrode connected to the reference voltage line 107.

The reference voltage line 107 may be connected to an external compensation circuit. An ADC of the external compensation circuit may be provided in a sensing channel of the data driver 110 and may be connected to a compensation circuit of the timing controller 130. The ADC converts a voltage received via the reference voltage line 107 in a sensing mode into a digital signal and outputs the digital signal indicating the electrical characteristics of the first transistor M01, for example, a threshold voltage, mobility, and the like. The compensation circuit of the timing controller 130 modulates the pixel data with a compensation value selected according to the digital signal input from the ADC. The external compensation circuit may compensate deviation (change) in electrical characteristic of the first transistor M01 in each pixel by modulating the pixel data (digital data) of the input video by deviation (or change) in electrical characteristic of the first transistor M01.

The display panel driving circuit may implement duty driving of the pixels to drive the light-emitting element with maximum light emission efficiency of the light-emitting element (e.g., the first light-emitting element LD1 or the second light-emitting element LD2). To implement the duty driving of the pixels, the timing controller 130 may divide one frame period into two or more sub-frame periods in a time-division manner to implement the duty driving of the pixels. For example, one frame period may include at least first and second sub-frame periods. During the first sub-frame period, the data voltage Vdata of the pixel data may be charged in the sub-pixels, and then, the light-emitting element may emit light and may be turned on with brightness corresponding to the grayscale value of the pixel data. During the second sub-frame period, the black grayscale voltage Vblack may be charged in the sub-pixels and the sub-pixels may be turned off. A turn-on period of the first sub-frame period and a turn-off period of the second sub-frame period determine a duty rate of the light-emitting element. The timing controller 130 may set or vary the turn-on period of the first sub-frame period and the turn-on period of the second sub-frame period by controlling the display panel driving circuit according to the duty rate of the light-emitting element. While the greater the duty rate of the light-emitting element becomes, the longer the turn-on period of the light-emitting element in one frame period may become, the smaller of the duty rate of the light-emitting element becomes, the shorter the turn-off period of the light-emitting element may become.

The grayscales of the pixels may be expressed by luminance in the pixels according to the voltage level or amplitude of the data voltage selected according to the grayscale value of the pixel data. Each sub-pixel may emit light wit luminance that varies depending on the voltage level of the data voltage Vdata applied to the data line 102, and may be turned off by the black grayscale voltage Vblack applied to the data line 102.

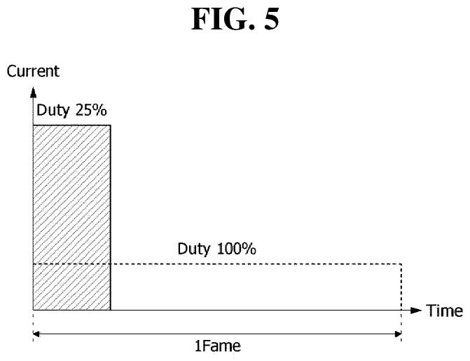

FIG. 4 is a diagram illustrating a current density to efficiency ratio characteristic by color of a micro LED that is used as a light-emitting element according to an embodiment of the present disclosure. In FIG. 4, the horizontal axis is a current density (A/cm²), and the vertical axis is an efficiency ratio of the light-emitting element by color to reference efficiency when the reference efficiency is “1”. The current density to efficiency ratio of the light-emitting element by color illustrated in FIG. 4 is a normalized value. As illustrated in FIG. 4, a maximum light emission efficiency period may be different among a micro LED of a red sub-pixel, a micro LED of a green sub-pixel, and a micro LED of a blue sub-pixel. When a driving current region of the micro LED by color is set in the maximum light emission efficiency period, power consumption can be reduced.

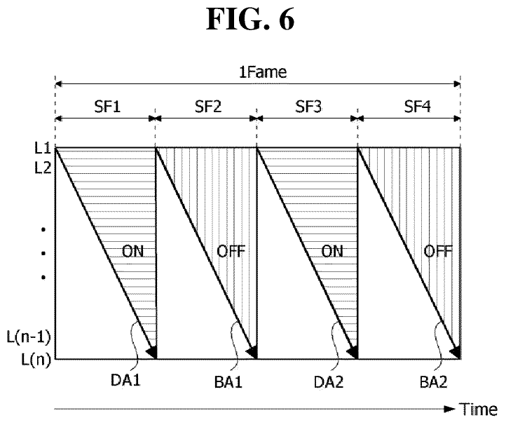

FIG. 5 is a diagram illustrating an example where a duty rate of a micro LED is different with the same target luminance according to an embodiment of the present disclosure. In FIG. 5, the horizontal axis is time, and the vertical axis is current.

As illustrated in FIG. 5, since the longer the turn-on time of the micro LED that is used as the light-emitting element becomes and the higher the current flowing in the light-emitting element is, the higher the luminance of the pixels becomes, the luminance can be expressed by time×current. When the micro LED is driven with a high current density for a short time, the light emission efficiency is high. For this reason, power consumption can be reduced with the same target luminance compared to a case where the micro LED is driven with a low current for a long time. For example, the micro LED is turned on about one frame period when the duty rate is 100% as indicated by a solid line, and the micro LED is turned on for about ¼ frame period when the duty rate is 25% as indicated by a dotted line. The micro LED is turned on for about ½ frame period when the duty rate is 50%.

Hereinafter, sub-pixels that are driven in the first viewing angle mode are referred to as “first sub-pixels”, and sub-pixels that are driven in the second viewing angle mode are referred to as “second sub-pixel”. Pixel data that is applied to the first sub-pixels is referred to as “first pixel data”, and pixel data that is applied to the second sub-pixels is referred to as “second pixel data”. The first pixel data may be video data of shared content, but the present disclosure is not limited thereto. The second pixel data may be video data of private content or content requiring privacy protection, but the present disclosure is not limited thereto. The first sub-pixels are sub-pixels in which the first light-emitting element LD1 may be turned on with brightness corresponding to the grayscale of the first pixel data, and the second light-emitting element LD2 is turned off. The second sub-pixels are sub-pixels in which the second light-emitting element LD2 may be turned on with brightness corresponding to the grayscale of the second pixel data, and the first light-emitting element LD1 is turned off. When the first pixel driving voltage EVDD1 has the first voltage level and the second pixel driving voltage EVDD2 has the second voltage level, the first light-emitting element LD1 may be turned on and illuminated, and the second light-emitting element LD2 is turned off and extinguished. Meanwhile, when the second pixel driving voltage EVDD2 has the first voltage level and the first pixel driving voltage EVDD1 has the second voltage level, the second light-emitting element LD2 may be turned on and illuminated, and the first light-emitting element LD1 is turned off and extinguished.

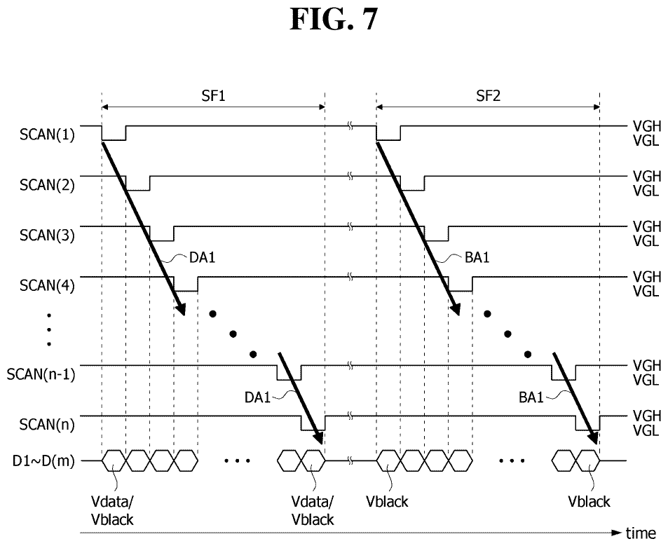

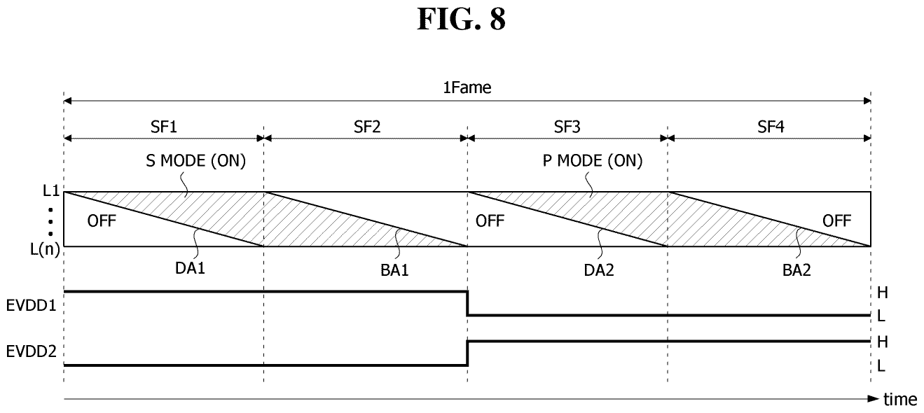

FIG. 6 is a diagram illustrating one frame period according to an embodiment of the present disclosure. FIG. 7 is a waveform chart illustrating an example of signals that are applied to data lines and gate lines during first and second sub-frame periods according to an embodiment of the present disclosure. In FIG. 7, “VGL” is a gate low voltage of a gate signal, and “VGH′” is a gate high voltage of a gate signal. “SCAN1 to SCAN(n)” indicate gate signals that are sequentially shifted in units of one pixel line, and D1 to D(m) indicate the data lines to which the data voltage Vdata of the pixel data or the black grayscale voltage Vblack is applied. In FIGS. 6 and 7, “DA1” indicates a first data addressing direction in which pixel data or black grayscale data is written to sub-pixels during a first sub-frame period SF1, and “BA1” indicates a second data addressing direction in which black grayscale data is written to sub-pixels during a second sub-frame period SF2. “DA2” indicates a third data addressing direction in which pixel data or black grayscale data is written to sub-pixels during a third sub-frame period SF3, and “BA2” indicates a fourth data addressing direction in which black grayscale data is written to sub-pixels during a fourth sub-frame period SF4.

Referring to FIGS. 6 to 8, one frame period may be divided into four sub-frame periods of the first sub-frame period SF1, the second sub-frame period SF2, the third sub-frame period SF3, and the fourth sub-frame period SF4 in a time-division manner.

During the first sub-frame period SF1, the first pixel data may be written to the first sub-pixels and the first sub-pixels may be turned on in the first viewing angle mode (S Mode). The first pixel data is charged as the data voltage Vdata in the first sub-pixels. During first sub-frame period SF1, the black grayscale data may be written to the second sub-pixels. The black grayscale data is charged as the black grayscale voltage Vblack in the second sub-pixels. Accordingly, during the first sub-frame period SF1, the first sub-pixels may be turned on in the first viewing angle mode (S Mode) after data addressing DA1, and the second sub-pixels are turned off.

During the second sub-frame period SF2, the black grayscale data may be written to the first sub-pixels and the second sub-pixels. During the second sub-frame period SF2, the first and second sub-pixels are turned off by the black grayscale data. Even when the first pixel driving voltage EVDD1 having the first voltage level is applied to the first sub-pixels, since the first transistor M01 to which the black grayscale voltage is applied is turned off, the first sub-pixels may be turned off during the second sub-frame period SF2. Accordingly, during the second sub-frame period SF2, all sub-pixels are turned off after data addressing BA1.

During the third sub-frame period SF3, the second pixel data may be written to the second sub-pixels and the second sub-pixels may be turned on in the second viewing angle mode (P Mode). The second pixel data is charged as the data voltage Vdata in the second sub-pixels. During the third sub-frame period SF3, the black grayscale data may be written to the first sub-pixels. The black grayscale data is charged as the black grayscale voltage Vblack in the first sub-pixels. Accordingly, during the third sub-frame period SF3, the second sub-pixels may be turned on in the second viewing angle mode (P Mode) after data addressing DA2, and the first sub-pixels are turned off.

During the fourth sub-frame period SF4, the black grayscale data may be written to the first sub-pixels and the second sub-pixels. During the fourth sub-frame period SF4, the first and second sub-pixels are turned off by the black grayscale data. Even when the second pixel driving voltage EVDD2 having the first voltage level is applied to the second sub-pixels, since the first transistor M01 to which the black grayscale voltage is applied is turned off, the second sub-pixels may be turned off during the fourth sub-frame period SF4. Accordingly, during the fourth sub-frame period SF4, all sub-pixels are turned off after data addressing BA1.

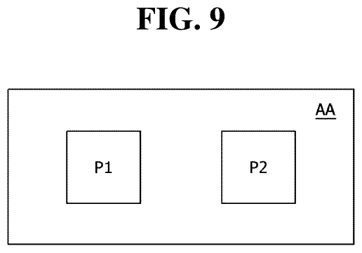

FIG. 8 is a waveform chart illustrating an example of first and second pixel driving voltages that are applied to the pixel circuit illustrated in FIG. 2 according to an embodiment of the present disclosure. In FIG. 8, “S Mode” indicates the first viewing angle mode, and “P Mode” indicates the second viewing angle mode. “ON” indicates a turn-on state of sub-pixels, and “OFF” indicates a turn-off state of sub-pixels.

Referring to FIG. 8, the first pixel driving voltage EVDD1 may have the first voltage level H during the first and second sub-frame periods SF1 and SF2 and have the second voltage level L during the third and fourth sub-frame periods SF3 and SF4. The second pixel driving voltage EVDD2 may have the second voltage level L during the first and second sub-frame periods SF1 and SF2 and have the first voltage level H during the third and fourth sub-frame periods SF3 and SF4. The first pixel driving voltage EVDD1 having the first voltage level H may turn on the first sub-pixels by causing the first light-emitting elements LD1 in the first sub-pixels to emit light.

The first sub-pixels may be driven and turned on during the first sub-frame period SF1 in one frame period, but may be turned off during the second to fourth sub-frame periods SF2, SF3, and SF4. Accordingly, the first sub-pixels may be turned on at the duty rate of 25%. The second sub-pixels may be driven and turned on during the third sub-frame period SF3 in one frame period, but may be turned off during the first, second, and fourth sub-frame periods SF1, SF2, and SF4. Accordingly, the second sub-pixels may be turned on at the duty rate of 25%.

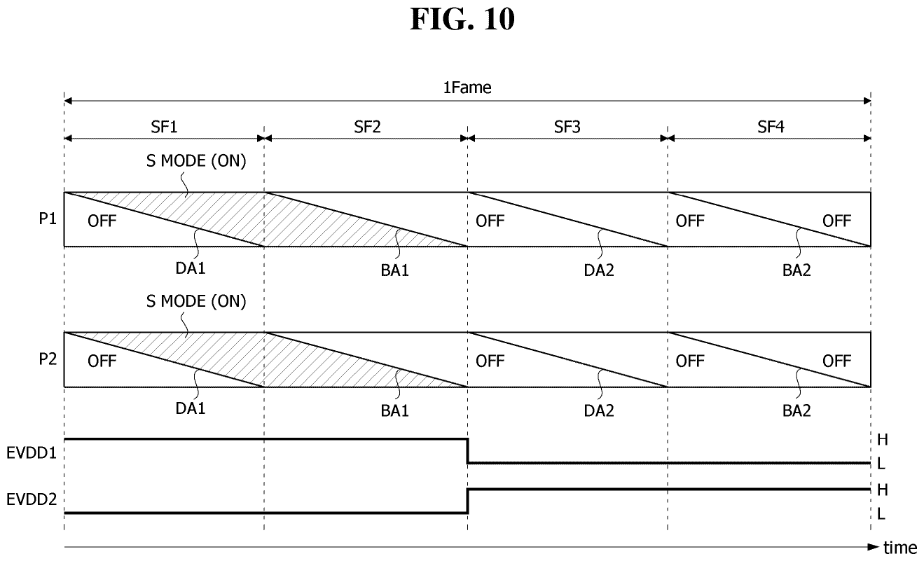

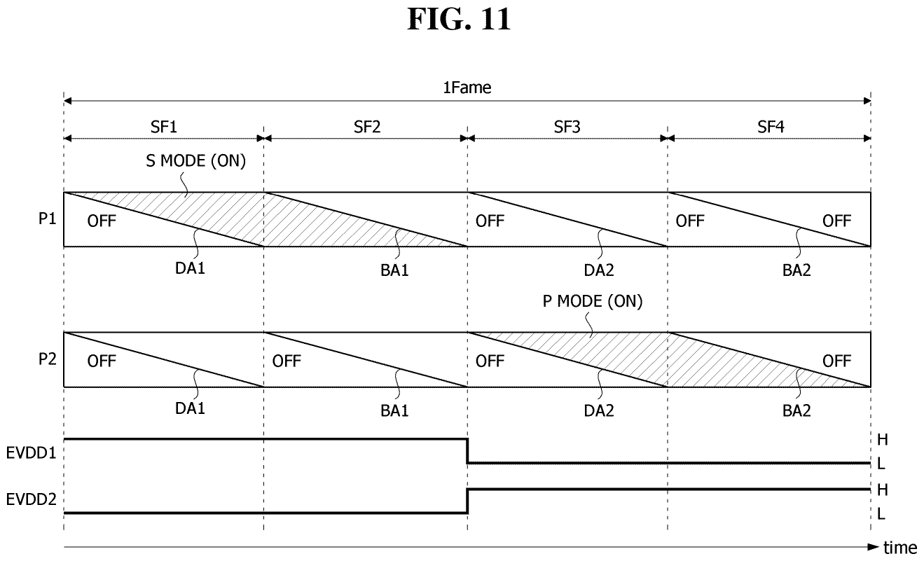

FIG. 9 is a diagram illustrating an example of pixels in which a viewing angle is controlled independently in the display area of the display panel. In the example of FIG. 9, the display area AA may include first and second sub-pixels P1 and P2 in which a viewing angle is controlled independently. It should be noted that the first and second sub-pixels P1 and P2 are not fixed to a certain viewing angle mode. The first and second sub-pixels P1 and P2 may be driven in the first viewing angle mode (S Mode) or the second viewing angle mode (P Mode) according to the voltages EVDD1 and EVDD2 that are individually applied to the light-emitting elements LD1 and LD2. A viewing angle control method of each of the first and second sub-pixels P1 and P2 will be described in connection with FIGS. 10 to 12.

Referring to FIGS. 2, 9, and 10, the first pixel data may be written to the first and second sub-pixels P1 and P2 during the first sub-frame period SF1, and then, the black grayscale data may be written to the first and second sub-pixels P1 and P2 during the second sub-frame period SF2. During the first and second sub-frame periods SF1 and SF2, while the first pixel driving voltage EVDD1 has the first voltage level H, the second pixel driving voltage EVDD2 has the second voltage level L. Accordingly, the first and second sub-pixels P1 and P2 may be turned on (ON) in the first viewing angle mode (S Mode) during the first sub-frame period SF1 and are in the turn-off state (OFF) during the second sub-frame period SF2.

During the third and fourth sub-frame periods SF3 and SF4, the black grayscale data is written to the first and second sub-pixels P1 and P2. During the third and fourth sub-frame periods SF3 and SF4, while the second pixel driving voltage EVDD2 has the first voltage level H, the first pixel driving voltage EVDD1 has the second voltage level L. The first and second sub-pixels P1 and P2 are in the turn-off state (OFF) by the black grayscale data during the third and fourth sub-frame periods SF3 and SF4.

Referring to FIGS. 2, 9, and 11, during the first sub-frame period SF1, the first pixel data is written to the first sub-pixel P1, and the black grayscale data is written to the second sub-pixel P2. During the second sub-frame period SF2, the black grayscale data may be written to the first and second sub-pixels P1 and P2. During the first and second sub-frame periods SF1 and SF2, while the first pixel driving voltage EVDD1 has the first voltage level H, the second pixel driving voltage EVDD2 has the second voltage level L. Accordingly, the first sub-pixel P1 may be turned on (ON) in the first viewing angle mode (S Mode) during the first sub-frame period SF1 and is in the turn-off state (OFF) during the second sub-frame period SF2. The second sub-pixel P2 is in the turn-off state (OFF) during the first and second sub-frame periods SF1 and SF2.

During the third sub-frame period SF3, the second pixel data is written to the second sub-pixel P2, and the black grayscale data is written to the first sub-pixel P1. During the fourth sub-frame period SF4, the black grayscale data may be written to the first and second sub-pixels P1 and P2. During the third and fourth sub-frame periods SF3 and SF4, while the second pixel driving voltage EVDD2 has the first voltage level H, the first pixel driving voltage EVDD1 has the second voltage level L. Accordingly, the second sub-pixel P2 may be turned on (ON) in the second viewing angle mode (P Mode) during the third sub-frame period SF3 and is in the turn-off state (OFF) during the fourth sub-frame period SF4. The first sub-pixel P1 is in the turn-off state (OFF) during the third and fourth sub-frame periods SF3 and SF4.

Referring to FIGS. 2, 9, and 12, during the first sub-frame period SF1, the first pixel data is written to the first and second sub-pixels P1 and P2. Subsequently, during the second sub-frame period SF2, the black grayscale data may be written to the first and second sub-pixels P1 and P2. During the first and second sub-frame periods SF1 and SF2, while the first pixel driving voltage EVDD1 has the first voltage level H, the second pixel driving voltage EVDD2 has the second voltage level L. Accordingly, the first and second sub-pixels P1 and P2 may be turned on (ON) in the first viewing angle mode (S Mode) during the first sub-frame period SF1 and are in the turn-off state (OFF) during the second sub-frame period SF2.

During the third sub-frame period SF3, the second pixel data is written to the second sub-pixel P2, and the black grayscale data is written to the first sub-pixel P1. During the fourth sub-frame period SF4, the black grayscale data may be written to the first and second sub-pixels P1 and P2. During the third and fourth sub-frame periods SF3 and SF4, while the second pixel driving voltage EVDD2 has the first voltage level H, the first pixel driving voltage EVDD1 has the second voltage level L. Accordingly, the second sub-pixel P2 may be turned on (ON) in the second viewing angle mode (P Mode) during the third sub-frame period SF3 and is in the turn-off state (OFF) during the fourth sub-frame period SF4. The first sub-pixel P1 is in the turn-off state (OFF) during the third and fourth sub-frame periods SF3 and SF4. In the example of FIG. 12, the first sub-pixels may be turned on at the duty rate of 25%, and the second sub-pixels may be turned at the duty rate of 25%.

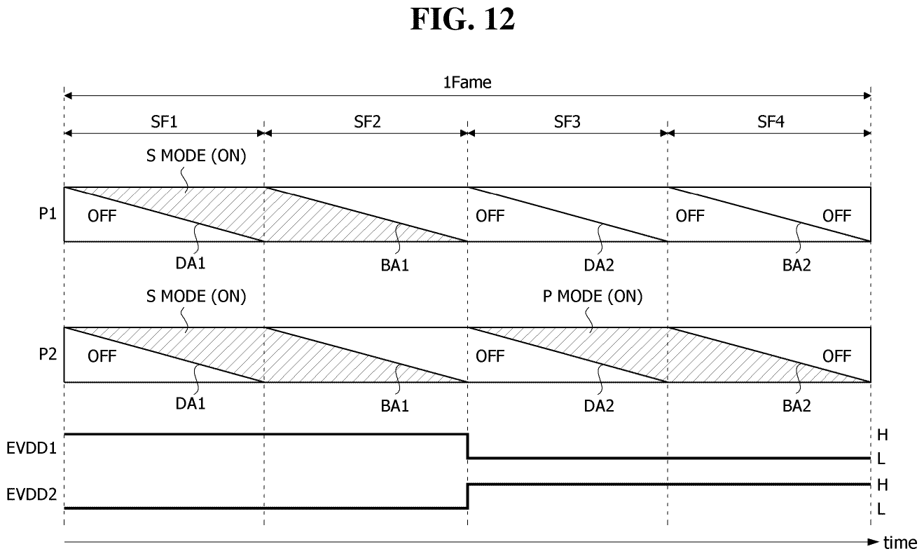

FIGS. 13, 14, and 15 are diagrams illustrating a method for applying the first and second pixel driving voltages EVDD1 and EVDD2 to the sub-pixels according to an embodiment of the present disclosure.

FIG. 13 is a diagram illustrating a connection structure of a display panel and circuit boards in the display device according to the embodiment of the present disclosure.

Referring to FIG. 13, source printed circuit boards (PCBs) 320 and 330 may be electrically connected to the display panel 100. A control PCB 300 may be electrically connected to the source PCBs 320 and 330 via a flexible soft cable, for example, a flexible flat cable (FFC) 310. The timing controller 130 and the power supply 140 may be provided on the control PCB 300. The level shifter 150 may be mounted on at least one of the control PCB 300 and the source PCBs 320 and 330. A non-volatile memory may be provided on one or more of the source PCBs 320 and 330. An initial compensation value of each sub-pixel and cumulative data values written to each sub-pixel may be stored in the non-volatile memory. The external compensation circuit may derive compensation values for compensating for deterioration of sub-pixels on the basis of the initial compensation value and the cumulative data values of each sub-pixel read from the memory.

Drive ICs SIC each including the data driver 110 may be mounted on flexible films of chips on film (COF) and may be connected between the source PCBs 320 and 330 and the display panel 100. The COFs electrically connect the source PCBs 320 and 330 to the display panel 100, apply the data voltage Vdata and the black grayscale voltage Vblack output from the data output channels of the data drivers 110 to the data lines of the display panel 100, and apply a sensing voltage received from the reference voltage line in the sensing mode to the sensing channels of the data drivers 110.

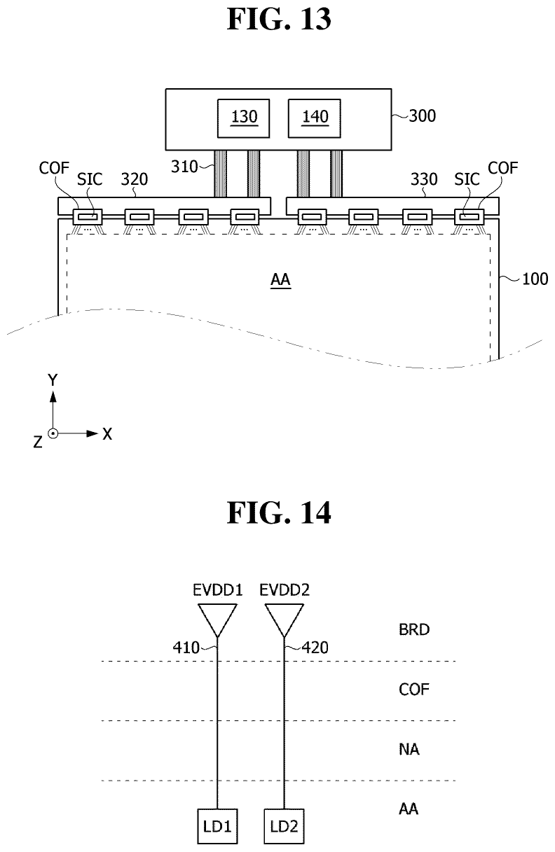

FIG. 14 is a diagram illustrating paths of first and second pixel driving voltage according to an embodiment of the present disclosure. In this embodiment, the power supply 140 may periodically reverse the first and second pixel driving voltages EVDD1 and EVDD2 under the control of the timing controller 130 as illustrated in FIGS. 8 to 12. In FIG. 14, “BRD” is a source PCB.

Referring to FIG. 14, first and second power lines 410 and 420 may be formed of wires extending across the COF, the non-display area NA, and the display area AA. The first pixel driving voltage EVDD1 output from the power supply 140 may be applied to the anode electrodes of the first light-emitting elements LD1 provided in sub-pixels P1 and P2 via the first power line 410. The second pixel driving voltage EVDD2 output from the power supply 140 may be applied to the anode electrodes of the second light-emitting element LD2 provided in the sub-pixels P1 and P2 via the second power line 420.

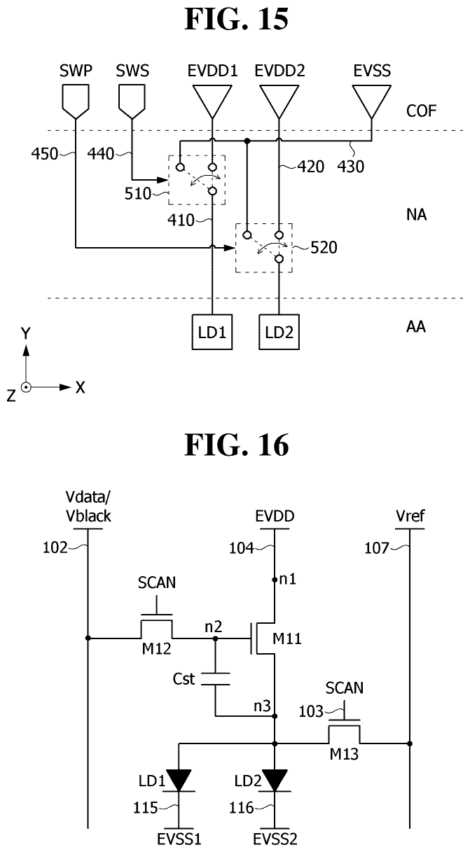

FIG. 15 is a diagram illustrating paths of first and second pixel driving voltage according to another embodiment of the present disclosure. In this embodiment, the power supply 140 may output first and second pixel driving voltages EVDD1 and EVDD2 that are a constant voltage (or a direct-current voltage) having the first voltage level H, for example, 9 V. The power supply 140 may output a pixel ground voltage EVSS that is the same voltage as the second voltage level, for example, 0 V.

Referring to FIG. 15, the display device may further include first and second switches 510 and 520 connected to power lines 410, 420, and 430. The first, and second, and third power lines 410, 420, and 430 may be formed of wires extending across the COF, the non-display area NA, and the display area AA. The first pixel driving voltage EVDD1 output from the power supply 140 may be applied to the anode electrodes of the first light-emitting elements LD1 provided in the sub-pixels P1 and P2 via the first power line 410. The second pixel driving voltage EVDD2 output from the power supply 140 may be applied to the anode electrodes of the second light-emitting element LD2 provided in the sub-pixels P1 and P2 via the second power line 420. The pixel ground voltage EVSS may be applied to the cathode electrodes of the first and second light-emitting elements LD1 and LD2 provided in the sub-pixels P1 and P2 via the third power line 430.

The first and second switches 510 and 520 may be provided on the non-display area NA of the display panel 100, but the present disclosure is not limited thereto. For example, the switches 510 and 520 may be provided on the flexible film of the COF or may be embedded in the drive IC SIC. The switches 510 and 520 may be implemented by transistors that are turned on/off in response to corresponding first and second control signals SWS and SWP. The control signals SWS and SWP may be output from the timing controller 130 or a logic circuit of the drive IC SIC and may be applied to control terminals or gate electrodes of the switches 510 and 520 via control signal wires 440 and 450. The control signal wires 440 and 450 may extend across the COF and the non-display area NA and may be connected to the switches 510 and 520.

The first switch 510 selects one of the first pixel driving voltage EVDD1 and the pixel ground voltage EVSS in response to the first control signal SWS and supplies selected one to the first light-emitting element LD1. For example, the first switch 510 may apply the first pixel driving voltage EVDD1 to the anode electrodes of the first light-emitting elements LD1 provided in the first and second sub-pixels P1 and P2 during the first and second sub-frame periods SF1 and SF2, and then, may apply the pixel ground voltage EVSS to the anode electrodes of the first light-emitting elements LD1 during the third and fourth sub-frame periods SF3 and SF4.

The second switch 520 selects one of the second pixel driving voltage EVDD2 and the pixel ground voltage EVSS in response to the second control signal SWP and supplies the selected one to the second light-emitting element LD2. For example, the second switch 520 may apply the pixel ground voltage EVSS to the anode electrodes of the second light-emitting elements LD2 provided in the first and second sub-pixels P1 and P2 during the first and second sub-frame periods SF1 and SF2, and then, may apply the second pixel driving voltage EVDD2 to the anode electrodes of the second light-emitting elements LD2 during the third and fourth sub-frame periods SF3 and SF4.

FIG. 16 is a circuit diagram illustrating a pixel circuit according to another embodiment of the present disclosure. In the following embodiments, redundant description to the above-described embodiment will not be repeated.

Referring to FIGS. 3 and 16, the pixel circuit includes a first light-emitting element LD1 that emits light in a first viewing angle mode, a second light-emitting element LD2 that emits light in a second viewing angle mode, a first transistor M11 that drives the first and second light-emitting elements LD1 and LD2, a capacitor Cst connected between a second node n2 and a third node n3, a second transistor M12 that electrically connects a data line 102 to the second node n2 in response to a gate on voltage of a gate signal SCAN, and a third transistor M13 that electrically connects a reference voltage line 107 to a third node n3 in response to the gate on voltage of the gate signal SCAN. The transistors M11, M12, and M13 may be implemented by n-channel transistors. In this case, the gate on voltage is a gate high voltage, and a gate off voltage is a gate low voltage.

The pixel circuit may be connected to wires such as the data line 102 to which a data voltage Vdata and a black grayscale voltage Vblack are applied, a gate line 103 to which the gate signal SCAN is applied, a first power line 104 to which a pixel driving voltage EVDD is applied, a second power line 115 to which a first pixel ground voltage EVSS1 is applied, a third power line 116 to which a second pixel ground voltage EVSS2 is applied, and a reference voltage line 107 to which a reference voltage Vref is applied.

The first pixel ground voltage EVSS1 may have a second voltage level L for causing the first light-emitting element LD1 turned on by lowering a cathode voltage of the first light-emitting element LD1 in the first viewing angle mode and have a first voltage level H for causing the first light-emitting element LD1 turned off by raising the cathode voltage of the first light-emitting element LD1 in the second viewing angle mode. The second pixel ground voltage EVSS2 may have a second voltage level L for causing the second light-emitting element LD2 turned on by lowering a cathode voltage of the second light-emitting element LD2 in the second viewing angle mode and have a first voltage level H for causing the second light-emitting element LD2 turned off by raising the cathode voltage of the second light-emitting element LD2 in the first viewing angle mode. The second voltage level L of each of the first and second pixel ground voltages EVSS1 and EVSS2 may be 2 V, but the present disclosure is not limited thereto. The first voltage level H of each of the first and second pixel ground voltages EVSS1 and EVSS2 may be 11 V, but the present disclosure is not limited thereto. The pixel driving voltage EVDD may be the same voltage as the first voltage level H of each of the first and second pixel ground voltages EVSS1 and EVSS2, for example, 11 V, but the present disclosure is not limited thereto.

The data voltage Vdata may be selectively set to a voltage corresponding to the grayscale value of the pixel data from voltages in a dynamic range of 1 V to 7 V, but the present disclosure is not limited thereto. The reference voltage Vref may be 1 V, but the present disclosure is not limited thereto. A voltage of the gate signal SCAN includes a pulse that swings between the gate high voltage and the gate low voltage. The gate high voltage may be 13 V and the gate low voltage may be −13 V, but the present disclosure is not limited thereto.

The first and second light-emitting elements LD1 and LD2 may be light-emitting elements such as an organic light emitting diode (OLED) or a micro LED, but the present disclosure is not limited thereto. An anode electrode of each of the first and second light-emitting elements LD1 and LD2 is connected to the third node n3. The first pixel ground voltage EVSS1 is applied to a cathode electrode of the first light-emitting element LD1, and the second pixel ground voltage EVSS2 is applied to a cathode electrode of the second light-emitting element LD2.

Each of sub-pixels may include the lenses 32 and 34 illustrated in FIG. 3. The first lens 32 overlaps a light emission area of the first light-emitting element LD1. The second lens 34 overlaps a light emission area of the second light-emitting element LD2.

The first transistor M11 includes a first electrode connected to the first node n1, a gate electrode connected to the second node n2, and a second electrode connected to the third node n3. The first node n1 is connected to the first power line 104. The capacitor Cst is connected between the second node n2 and the third node n3 and is charged with a gate-source voltage of the first transistor M11.

The second transistor M12 is connected between the data line 102 and the second node n2 and is turned on in response to the gate on voltage of the gate signal SCAN to electrically connect the data line 102 to the second node n2. The second transistor M12 includes a first electrode connected to the data line 102, a gate electrode connected to the gate line 103 to which the gate signal SCAN is applied, and a second electrode connected to the second node n2.

The third transistor M13 is connected between the reference voltage line 107 and the third node n3 and is turned on in response to the gate on voltage of the gate signal SCAN to electrically connect the third node n3 to the reference voltage line 107. The third transistor M13 includes a first electrode connected to the third node n3, a gate electrode connected to the gate line 103, and a second electrode connected to the reference voltage line 107. The reference voltage line 107 may be connected to the external compensation circuit.

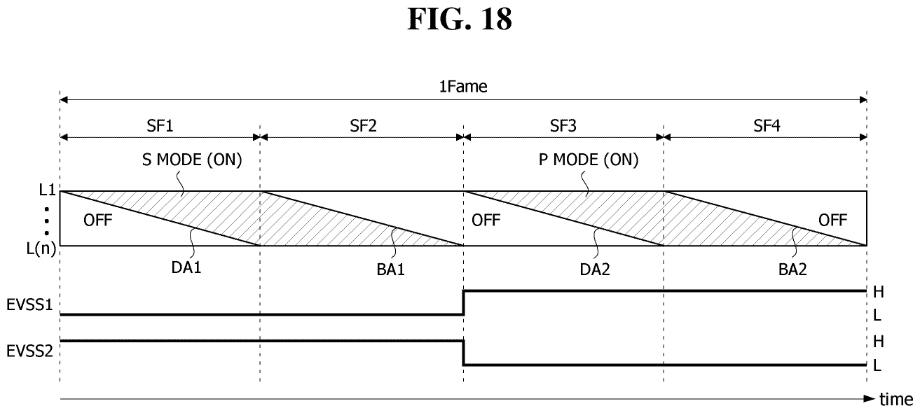

A duty driving method of the pixel circuit illustrated in FIG. 16 is as illustrated in FIGS. 6 to 18. One frame period may be divided into a first sub-frame period SF1, a second sub-frame period SF2, a third sub-frame period SF3, and a fourth sub-frame period SF4 in a time-division manner. During the first sub-frame period SF1, first pixel data may be written to first sub-pixels and the first sub-pixels may be turned on in the first viewing angle mode (S Mode). During the first sub-frame period SF1, black grayscale data may be written to second sub-pixels. During the second sub-frame period SF2, the black grayscale data may be written to the first sub-pixels and the second sub-pixels. During the third sub-frame period SF3, second pixel data may be written to the second sub-pixels and the second sub-pixels may be turned on in the second viewing angle mode (P Mode). During the third sub-frame period SF3, the black grayscale data may be written to the first sub-pixels. During the fourth sub-frame period SF4, the black grayscale data may be written to the first sub-pixels and the second sub-pixels.

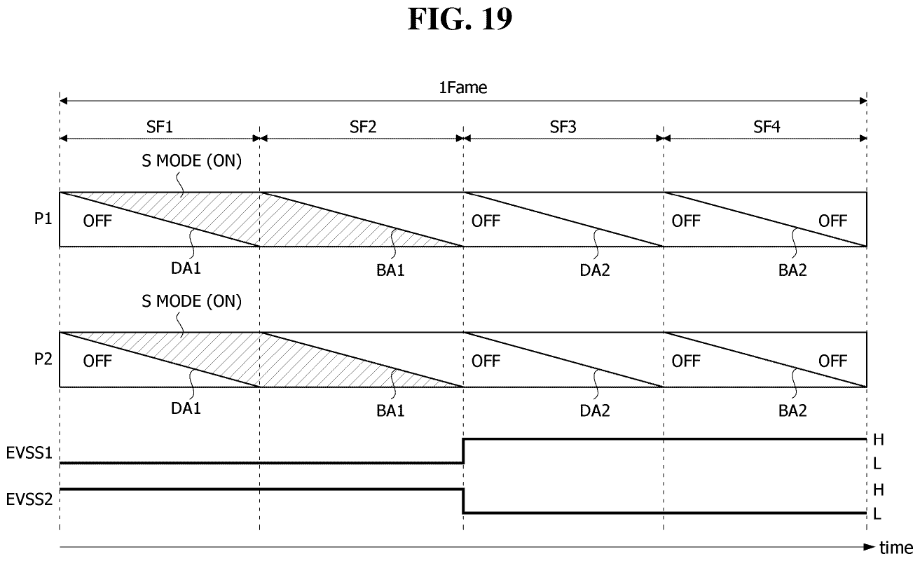

FIG. 18 is a waveform chart illustrating an example of the first and second pixel ground voltages that are applied to the pixel circuit illustrated in FIG. 16 according to an embodiment of the present disclosure.

Referring to FIG. 18, the first pixel ground voltage EVSS1 may have the second voltage level L during the first and second sub-frame periods SF1 and SF2 and have the first voltage level H during the third and fourth sub-frame periods SF3 and SF4. The second pixel ground voltage EVSS2 may have the first voltage level H during the first and second sub-frame periods SF1 and SF2 and have the first voltage level H during the third and fourth sub-frame periods SF3 and SF4. The first pixel ground voltage EVSS1 having the second voltage level L may turn on the first sub-pixels by causing the first light-emitting elements LD1 in the first sub-pixels to emit light.

The first sub-pixels may be driven and turned on during the first sub-frame period SF1 in one frame period, but may be turned off during the second to fourth sub-frame periods SF2, SF3, and SF4. Accordingly, the first sub-pixels may be turned on at the duty rate of 25%. The second sub-pixels may be driven and turned on during the third sub-frame period SF3 in one frame period, but may be turned off during the first, second, and fourth sub-frame periods SF1, SF2, and SF4. Accordingly, the second sub-pixels may be turned on at the duty rate of 25%.

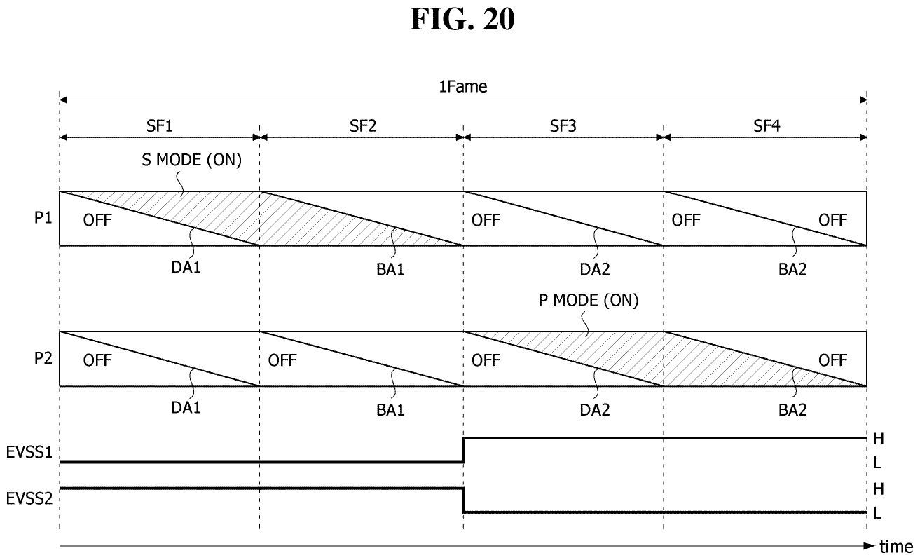

FIGS. 19 to 21 are diagrams illustrating a viewing angle control method of first and second sub-pixels to which the pixel circuit illustrated in FIG. 16 is applied.

Referring to FIGS. 9, 16, and 19, the first pixel data may be written to the first and second sub-pixels P1 and P2 during the first sub-frame period SF1, and then, the black grayscale data may be written to the first and second sub-pixels P1 and P2 during the second sub-frame period SF2. During the first and second sub-frame periods SF1 and SF2, while the first pixel ground voltage EVSS1 has the second voltage level L, the second pixel ground voltage EVSS2 has the first voltage level H. Accordingly, the first and second sub-pixels P1 and P2 may be turned on (ON) in the first viewing angle mode (S Mode) during the first sub-frame period SF1 and are in the turn-off state (OFF) during the second sub-frame period SF2.

During the third and fourth sub-frame periods SF3 and SF4, the black grayscale data is written to the first and second sub-pixels P1 and P2. During the third and fourth sub-frame periods SF3 and SF4, while the second pixel ground voltage EVSS2 has the second voltage level L, the first pixel ground voltage EVSS1 has the first voltage level H. The first and second sub-pixels P1 and P2 are in the turn-off state (OFF) by the black grayscale data during the third and fourth sub-frame periods SF3 and SF4.

Referring to FIGS. 9, 16, and 20, during the first sub-frame period SF1, the first pixel data is written to the first sub-pixel P1, and the black grayscale data is written to the second sub-pixel P2. During the second sub-frame period SF2, the black grayscale data may be written to the first and second sub-pixels P1 and P2. During the first and second sub-frame periods SF1 and SF2, while the first pixel ground voltage EVSS1 has the second voltage level L, the second pixel ground voltage EVSS2 has the first voltage level H. Accordingly, the first sub-pixel P1 may be turned on (ON) in the first viewing angle mode (S Mode) during the first sub-frame period SF1 and is in the turn-off state (OFF) during the second sub-frame period SF2. The second sub-pixel P2 is in the turn-off state (OFF) during the first and second sub-frame periods SF1 and SF2.

During the third sub-frame period SF3, the second pixel data is written to the second sub-pixel P2, and the black grayscale data is written to the first sub-pixel P1. During the fourth sub-frame period SF4, the black grayscale data may be written to the first and second sub-pixels P1 and P2. During the third and fourth sub-frame periods SF3 and SF4, while the second pixel ground voltage EVSS2 has the second voltage level L, the first pixel ground voltage EVSS1 has the first voltage level H. Accordingly, the second sub-pixel P2 may be turned on (ON) in the second viewing angle mode (P Mode) during the third sub-frame period SF3 and is in the turn-off state (OFF) during the fourth sub-frame period SF4. The first sub-pixel P1 is in the turn-off state (OFF) during the third and fourth sub-frame periods SF3 and SF4.

Referring to FIGS. 9, 16, and 21, during the first sub-frame period SF1, the first pixel data is written to the first and second sub-pixels P1 and P2. Subsequently, during the second sub-frame period SF2, the black grayscale data may be written to the first and second sub-pixels P1 and P2. During the first and second sub-frame periods SF1 and SF2, while the first pixel ground voltage EVSS1 has the second voltage level L, the second pixel ground voltage EVSS2 has the first voltage level H. Accordingly, the first and second sub-pixels P1 and P2 may be turned on (ON) in the first viewing angle mode (S Mode) during the first sub-frame period SF1 and is in the turn-off state (OFF) during the second sub-frame period SF2.

During the third sub-frame period SF3, the second pixel data is written to the second sub-pixel P2, and the black grayscale data is written to the first sub-pixel P1. During the fourth sub-frame period SF4, the black grayscale data may be written to the first and second sub-pixels P1 and P2. During the third and fourth sub-frame periods SF3 and SF4, while the second pixel ground voltage EVSS2 has the second voltage level L, the first pixel ground voltage EVSS1 has the first voltage level H. Accordingly, the second sub-pixel P2 may be turned on (ON) in the second viewing angle mode (P Mode) during the third sub-frame period SF3 and is in the turn-off state (OFF) during the fourth sub-frame period SF4. The first sub-pixel P1 is in the turn-off state (OFF) during the third and fourth sub-frame periods SF3 and SF4. In the example of FIG. 21, the first sub-pixels may be turned on at the duty rate of 25%, and the second sub-pixels may be turned on at the duty rate of 25%.

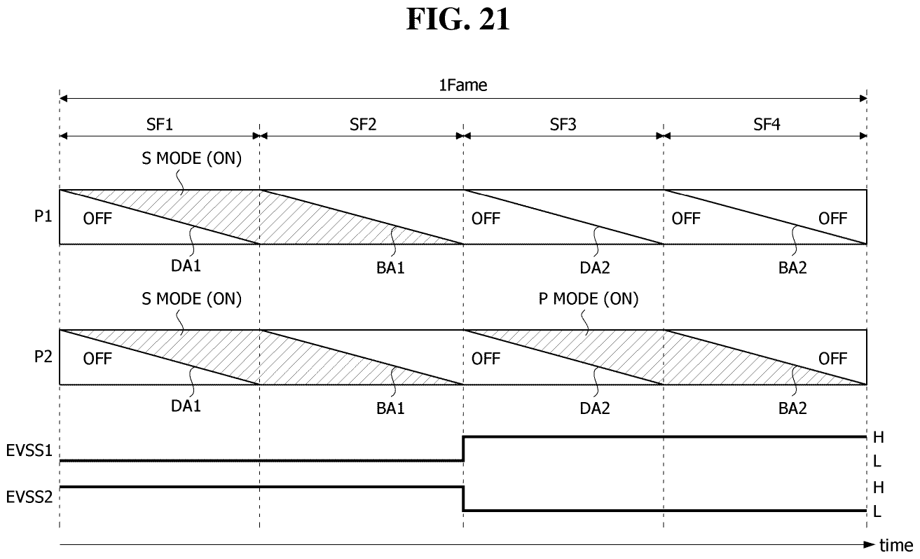

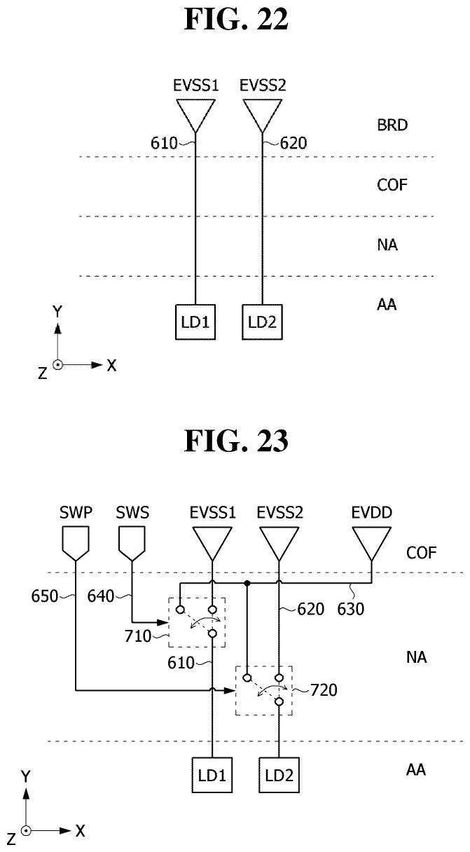

FIGS. 22 and 23 are drawings illustrating a method for applying the first and second pixel ground voltages EVSS1 and EVSS2 to the sub-pixels according to an embodiment of the present disclosure.

FIG. 22 is a drawing illustrating paths of first and second pixel ground voltages according to an embodiment of the present disclosure. In this embodiment, the power supply 140 may periodically reverse the first and second pixel ground voltages EVSS1 and EVSS2 under the control of the timing controller 130 as illustrated in FIGS. 18 to 21.

Referring to FIG. 22, power lines 610 and 620 to which the pixel ground voltages EVSS1 and EVSS2 are applied may be formed of wires extending across the COF, the non-display area NA, and the display area AA. The first pixel ground voltage EVSS1 output from the power supply 140 may be applied to the cathode electrodes of the first light-emitting elements LD1 provided in the sub-pixels P1 and P2 via the second power line 610. The second pixel ground voltage EVSS2 output from the power supply 140 may be applied to the anode electrodes of the second light-emitting elements LD2 provided in the sub-pixels P1 and P2 via the third power line 620.

FIG. 23 is a diagram illustrating paths of first and second pixel ground voltages according to another embodiment of the present disclosure. In this embodiment, the power supply 140 may output first and second pixel ground voltages EVSS1 and EVSS2 that are a constant voltage (or a direct-current voltage) having the second voltage level L, for example, 0 V. The power supply 140 may output a pixel driving voltage EVDD that is the same voltage as the first voltage level H, for example, 9 V.

Referring to FIG. 23, the display device may further include first and second switches 710 and 720 connected to power lines 610, 620, and 630. The power lines 610, 620, and 630 may be formed of wires extending across the COF, the non-display area NA, and the display area AA. The first pixel ground voltage EVSS1 output from the power supply 140 may be applied to the cathode electrodes of the first light-emitting elements LD1 provided in the sub-pixels P1 and P2 via the second power line 610. The second pixel ground voltage EVSS2 output from the power supply 140 may be applied to the cathode electrodes of the second light-emitting elements LD2 provided in the sub-pixels P1 and P2 via the third power line 620. The pixel driving voltage EVDD may be applied to the anode electrodes of the first and second light-emitting elements LD1 and LD2 provided in the sub-pixels P1 and P2 via the first power line 630.

The switches 710 and 720 may be implemented by transistors that are turned on/off in response to corresponding control signals SWS and SWP. Control signal wires 640 and 650 may extend across the COF and the non-display area NA and may be connected to the switches 710 and 720.

The first switch 710 selects one of the pixel driving voltage EVDD and the first pixel ground voltage EVSS1 in response to the first control signal SWS and supplies the selected one to the first light-emitting element LD1. For example, the first switch 710 may apply the first pixel ground voltage EVSS1 to the cathode electrodes of the first light-emitting elements LD1 provided in the first and second sub-pixels P1 and P2 during the first and second sub-frame periods SF1 and SF2, and then, may apply the pixel driving voltage EVDD to the cathode electrodes of the first light-emitting elements LD1 during the third and fourth sub-frame periods SF3 and SF4.

The second switch 720 selects one of the pixel driving voltage EVDD and the second pixel ground voltage EVSS2 in response to the second control signal SWP and supplies the selected one to the second light-emitting element LD2. For example, the second switch 720 may apply the pixel driving voltage EVDD to the cathode electrodes of the second light-emitting elements LD2 provided in the first and second sub-pixels P1 and P2 during the first and second sub-frame periods SF1 and SF2, and then, may apply the second pixel ground voltage EVSS2 to the cathode electrodes of the second light-emitting elements LD2 during the third and fourth sub-frame periods SF3 and SF4.

According to one or more embodiments of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the present disclosure may be applied to organic light emitting lighting devices or inorganic light emitting lighting devices.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A display panel comprising:
a plurality of data lines;
a plurality of gate lines;
a plurality of power lines; and
a plurality of sub-pixels that are electrically connected to the plurality of data lines, the plurality of gate lines, and the plurality of power lines,
wherein each of the plurality of sub-pixels includes:
a first light-emitting element,
a second light-emitting element, and
a first transistor connected to the first light-emitting element and the second light-emitting element, and
wherein a first alternating-current voltage that is applied to one electrode of an anode electrode and a cathode electrode of the first light-emitting element periodically changes between a first voltage and a second voltage,
wherein a second alternating-current voltage that is applied to one electrode of an anode electrode and a cathode electrode of the second light-emitting element periodically changes between the first voltage and the second voltage, and
wherein the second voltage is less than the first voltage.

2. The display panel according to claim 1, further comprising:
a first lens that overlaps a light emission area of the first light-emitting element; and
a second lens that overlaps a light emission area of the second light-emitting element.

3. The display panel according to claim 1, wherein the first alternating-current voltage applied to the first light-emitting element and the second alternating-current voltage applied to the second light-emitting element have waveforms with phases opposite to each other.

4. The display panel according to claim 1, wherein, when the first alternating-current voltage applied to the first light-emitting element is the first voltage, the second alternating-current voltage applied to the second light-emitting element is the second voltage.

5. The display panel according to claim 1, further comprising:
a first switch element configured to select one of the first voltage and the second voltage and supply the selected one to the first light-emitting element; and
a second switch element configured to select one of the first voltage and the second voltage and supply the selected one to the second light-emitting element.

6. The display panel according to claim 1, wherein the sub-pixel further includes:
a capacitor connected to a first node and a second node,
a second transistor that is turned on in response to a gate on voltage of a gate signal applied to a gate line from the plurality of gate lines and electrically connects a data line from the plurality of data lines to the second node, and
a third transistor that is turned on in response to the gate on voltage of the gate signal and electrically connects the first node to a reference voltage line, and
wherein cathode electrode of the first light-emitting element and the cathode electrode of the second light-emitting element are connected to the first node,
a first power line from the plurality of power lines to which the first alternating-current voltage is applied is connected to the anode electrode of the first light-emitting element,
a second power line from the plurality of power lines to which the second alternating-current voltage is applied is connected to the anode electrode of the second light-emitting element, and
a third power line from the plurality of power lines to which a pixel ground voltage is applied is connected to a third node.

7. The display panel according to claim 6, wherein the first transistor includes a first electrode connected to the first node, a gate electrode connected to the second node, and a second electrode connected to the third node,
the second transistor includes a first electrode connected to the data line, a gate electrode connected to the gate line, and a second electrode connected to the second node,
the third transistor includes a first electrode connected to the first node, a gate electrode connected to the gate line, and a second electrode connected to the reference voltage line, and
wherein a data voltage of pixel data or a black grayscale voltage is applied to the data line.

8. The display panel according to claim 6, wherein the pixel ground voltage has a same voltage level as that of the second voltage.

9. The display panel according to claim 1, wherein the sub-pixel further includes:
a capacitor connected to a second node and a third node,
a second transistor that is turned on in response to a gate on voltage of a gate signal applied to a gate line from the plurality of gate lines and electrically connects a data line from the plurality of data lines to the second node, and
a third transistor that is turned on in response to the gate on voltage of the gate signal and electrically connect the third node to a reference voltage line, and
wherein the anode electrode of the first light-emitting element and the anode electrode of the second light-emitting element are connected to the third node,
a first power line from the plurality of power lines to which a pixel driving voltage is applied is connected to a first node,
a second power line from the plurality of power lines to which the first alternating-current voltage is applied is connected to the cathode electrode of the first light-emitting element, and
a third power line from the plurality of power lines to which the second alternating-current voltage is applied is connected to the cathode electrode of the second light-emitting element.

10. The display panel according to claim 9, wherein the first transistor includes a first electrode connected to the first node, a gate electrode connected to the second node, and a second electrode connected to the third node,
the second transistor includes a first electrode connected to the data line, a gate electrode connected to the gate line, and a second electrode connected to the second node,
the third transistor includes a first electrode connected to the third node, a gate electrode connected to the gate line, and a second electrode connected to the reference voltage line, and
wherein a data voltage of pixel data or a black grayscale voltage is applied to the data line.

11. The display panel according to claim 9, wherein the pixel driving voltage has a same voltage level as that of the first voltage.

12. The display panel according to claim 1, wherein the first light-emitting element emits light in a first viewing angle mode and the second light-emitting element emits light in a second viewing angle mode having a viewing angle that is different from a viewing angle in the first viewing angle mode.

13. A display device comprising:
a display panel in which a plurality of data lines, a plurality of gate lines, a plurality of power lines, and a plurality of sub-pixels that are electrically connected to the plurality of data lines, the plurality of gate lines, and the plurality of power lines are disposed;
a data driver electrically connected to the plurality of data lines; and
a gate driver electrically connected to the plurality of gate lines,
wherein each of the plurality of sub-pixels includes:
a first light-emitting element,
a second light-emitting element, and
a first transistor connected to the first light-emitting element and the second light-emitting element, and
wherein a first alternating-current voltage that is applied to one electrode of an anode electrode and a cathode electrode of the first light-emitting element periodically changes between a first voltage and a second voltage,
a second alternating-current voltage that is applied to one electrode of an anode electrode and a cathode electrode of the second light-emitting element periodically changes between the first voltage and the second voltage, and
wherein the second voltage is less than the first voltage.

14. The display device according to claim 13, wherein the sub-pixel further includes:
a capacitor connected to a first node and a second node,
a second transistor that is turned on in response to a gate on voltage of a gate signal applied to a gate line from the plurality of gate lines and electrically connects a data line from the plurality of data lines to the second node, and
a third transistor that is turned on in response to the gate on voltage of the gate signal applied to the gate line and electrically connects the first node to a reference voltage line, and
wherein the cathode electrode of the first light-emitting element and the cathode electrode of the second light-emitting element are connected to the first node,
a first power line from the plurality of power lines to which the first alternating-current voltage is applied is connected to the anode electrode of the first light-emitting element,
a second power line from the plurality of power lines to which the second alternating-current voltage is applied is connected to the anode electrode of the second light-emitting element, and
a third power line from the plurality of power lines to which a pixel ground voltage is applied is connected to a third node.

15. The display device according to claim 14, wherein the first transistor includes a first electrode connected to the first node, a gate electrode connected to the second node, and a second electrode connected to the third node,
the second transistor includes a first electrode connected to the data line, a gate electrode connected to the gate line, and a second electrode connected to the second node, and
wherein the third transistor includes a first electrode connected to the first node, a gate electrode connected to the gate line, and a second electrode connected to the reference voltage line,
wherein a data voltage of pixel data or a black grayscale voltage is applied to the data line,
wherein the pixel ground voltage has a same voltage level as that of the second voltage,
wherein the first light-emitting element emits light in a first viewing angle mode and
the first light-emitting element emits light in a second viewing angle mode having a viewing angle that is different from a viewing angle in the first viewing angle mode.

16. The display device according to claim 13, wherein the sub-pixel further includes:
a capacitor connected to a second node and a third node,
a second transistor that is turned on in response to a gate on voltage of a gate signal applied to a gate line from the plurality of gate lines and electrically connects a data line from the plurality of data lines to the second node, and
a third transistor that is turned on in response to the gate on voltage of the gate signal to electrically connect the third node to a reference voltage line, and
wherein the anode electrode of the first light-emitting element and the anode electrode of the second light-emitting element are connected to the third node,
a first power line from the plurality of power lines to which a pixel driving voltage is applied is connected to a first node,
a second power line from the plurality of power lines to which the first alternating-current voltage is applied is connected to the cathode electrode of the first light-emitting element, and
a third power line from the plurality of power lines to which the second alternating-current voltage is applied is connected to the cathode electrode of the second light-emitting element.

17. The display device according to claim 16, wherein the first transistor includes a first electrode connected to the first node, a gate electrode connected to the second node, and a second electrode connected to the third node,
the second transistor includes a first electrode connected to the data line, a gate electrode connected to the gate line, and a second electrode connected to the second node,
the third transistor includes a first electrode connected to the third node, a gate electrode connected to the gate line, and a second electrode connected to the reference voltage line,
wherein a data voltage of pixel data or a black grayscale voltage is applied to the data line,
wherein the pixel driving voltage has a same voltage level as that of the first voltage,
wherein the first light-emitting element emits light in a first viewing angle mode and the first light-emitting element emits light in a second viewing angle mode having a viewing angle that is different from a viewing angle in the first viewing angle mode.

18. The display device according to claim 13, further comprising:
a timing controller configured to transmit pixel data of an input video to the data driver and control operation timings of the data driver and the gate driver,
wherein the timing controller divides one frame period into at least a first sub-frame period, a second sub-frame period, a third sub-frame period, and a fourth sub-frame period.

19. The display device according to claim 18, wherein a data voltage of first pixel data or a black grayscale voltage is applied to the plurality of data lines during the first sub-frame period,
the black grayscale voltage is applied to the plurality of data lines during the second sub-frame period,
a data voltage of second pixel data or the black grayscale voltage is applied to the plurality of data lines during the third sub-frame period,
the black grayscale voltage is applied to the plurality of data lines during the fourth sub-frame period,
the first alternating-current voltage is applied to the anode electrode of the first light-emitting element,
the second alternating-current voltage is applied to the anode electrode of the second light-emitting element,
a pixel ground voltage set as the second voltage is applied to the cathode electrode of the first light-emitting element and the cathode electrode of the second light-emitting element,
during the first sub-frame period and the second sub-frame period, the first alternating-current voltage is the first voltage and the second alternating-current voltage is the second voltage, and
during the third sub-frame period and the fourth sub-frame period, the first alternating-current voltage is the second voltage and the second alternating-current voltage is the first voltage.

20. The display device according to claim 18, wherein a data voltage of first pixel data or a black grayscale voltage is applied to the plurality of data lines during the first sub-frame period,
the black grayscale voltage is applied to the plurality of data lines during the second sub-frame period,
a data voltage of second pixel data or a black grayscale voltage is applied to the plurality of data lines during the third sub-frame period,
the black grayscale voltage is applied to the plurality of data lines during the fourth sub-frame period,
a pixel driving voltage set as the first voltage is applied to the anode electrode of the first light-emitting element and the anode electrode of the second light-emitting element,
the first alternating-current voltage is applied to the cathode electrode of the first light-emitting element,
the second alternating-current voltage is applied to the cathode electrode of the second light-emitting element,
during the first sub-frame period and the second sub-frame period, the first alternating-current voltage is the second voltage and the second alternating-current voltage is the first voltage, and
during the third sub-frame period and the fourth sub-frame period, the first alternating-current voltage is the first voltage and the second alternating-current voltage is the second voltage.
